(19) United States
(12) Patent Application Publication
(10) Pub. No.: US 2019/0149717 A1
(43) Pub. Date: May 16, 2019

(54) Remotely Controlled Filter

(71) Applicant: Jeffrey Paul Overall, Fountain Valley, CA (US)

(72) Inventor: Jeffrey Paul Overall, Fountain Valley, CA (US)

(21) Appl. No.: 15/813,371

(22) Filed: Nov. 15, 2017

(51) Int. Cl. H04N 5/232; H04N 5/225; G02B 5/30; G02B 26/00

(52) U.S. Cl. CPC H04N 5/23206; H04N 5/2254; B64C 39/024; G02B 26/00; G02B 5/3025

(57) ABSTRACT

Devices and methods of adjusting a camera filter while it is mounted on a camera. The filter frame or camera lens housing contains mechanical components permitting rotation of polarizer glass. Commands can be received by remote transmission and used to orient the polarizer glass to the desired angle. In-trip adjustments of filters attached to drone cameras and other unmanned vehicles is possible.

### FIELD OF INVENTION

The present invention relates to the correction of polarization and light correction in photography and videography. Specifically, it relates to remote control of polarizer camera filters and other optical devices.

### LIST OF PRIOR ART

| | | U.S. Patents | |
|---|---|---|---|
| Patent Number: | Kind Code: | Grant Date: | Patentee: |
| 3,469,260 | A | 1969 Sep. 23 | Holt |
| 3,554,105 | A | 1971 Jan. 12 | Dougherty |
| 3,564,134 | A | 1971 Feb. 16 | Rue |
| 5,323,203 | A | 1994 Jun. 21 | Maruyama |
| 6,028,303 | A | 2000 Feb. 22 | Suzuki |
| 7,039,311 | B2 | 2006 May 2 | Nomura |
| 8,200,375 | B2 | 2012 Jun. 12 | Stuckman |
| 8,508,646 | B2 | 2013 Aug. 13 | Katerberg |
| 8,908,573 | B1 | 2014 Dec. 9 | Wang |
| 9,004,973 | B2 | 2015 Apr. 14 | Condon |
| Publication Number: | Kind Code: | Publ. Date | Applicant: |
| 20150042818 | A1 | 2014 Aug. 4 | Wada |

### BACKGROUND/PRIOR ART

Drones and other unmanned vehicles are used recreationally and to perform professional tasks. Cameras are integrated into or can be attached to drones. Drones allow a photographer or videographer to conveniently capture aerial footage. Image and command data can be transferred between the operator and the drone and drone camera via remote control, or other transponder or transceiver. User interfaces displaying the footage captured by the drone are either integrated into the control system or attached thereto.

High quality photography requires the use of lens filters to modify the light penetrating the camera lens. Polarizer filters improve image contrast and saturation and reduce glare from reflections by correcting the polarization of light caused by specular reflections and atmospheric scatter. These problems are particularly acute in aerial footage, as atmospheric scatter can cause attenuation of sky color and reflection can be intensified by distance and vantage point. Though software programs can eliminate many visual flaws, polarized light is not separately recorded by cameras and software programs are not capable of correcting the unwanted polarization. This makes correct filtration of polarized light at the time of filming necessary.

Polarizer filters improve image quality by absorbing polarized light. Polarization occurs when light waves travel in directions non-perpendicular to the camera lens. The polarizer is set over the lens at the angle allowing for maximum absorption of polarized light. The filter is rotated around the polarization axis located in the center of the light transmissive element and perpendicular to the surface of the frame. The polarizer allows adjustments within a range of angles relative to the polarization axis, accounting for the angle of incidence to the sun. Before applying the filter to the camera, a photographer can determine the appropriate angle by looking through the filter and rotating it. The filter can then be applied to the camera, with further adjustments if necessary.

Drone photography presents unique problems in determining and maintaining the correct level of polarization filtration. First, when applying the filter, the photographer must determine the appropriate polarization angle based on conditions on the ground. This angle can change across different elevations. Second, the correct angle of polarization will change during a flight of extended duration due to rotation of the earth. This can lead to in-flight increases in polarization, and lower quality photographs or video footage.

The present invention allows adjustment of a polarizer filter while a drone is airborne. The filter can be remotely rotated around the polarization axis while coupled with the drone camera. Necessary adjustments can be made in-flight via remote control based on aerial perspective and lighting changes as perceived by the photographer.

### SUMMARY

The exemplary embodiment includes a camera filter with a stationary component of the frame capable of coupling with the camera lens housing. An exemplary embodiment is a self-contained camera filter, capable of removable coupling with a DSLR camera, drone camera, or other image capture device. The frame surrounds polarizer glass, or a light transmissive element. The light transmissive element, is operatively coupled with the frame and rotated by a mechanical component. In the exemplary embodiment, the mechanical component is comprised of a drive ring and a crank drive. The drive ring is a circular implement within the frame. The drive ring is capable of rotation relative to the frame. The inner edge of the drive ring is conjoined with the outer edge of the light transmissive element.

The drive ring has a section of gear ridges on its outer edge. The outer edge of the frame wall has an open section allowing access to a control hub. The control hub contains the crank drive. The crank drive contains ridges that interlock with and exert rotational force on the gear ridges of the drive ring. The gear ridges extend over a sufficient distance to permit the necessary rotation of the light transmissive element to the orientation of desired polarization.

A receiver is enclosed in or positioned on the control hub. The receiver is a device capable of receiving and processing data transmitted from a remote controller. The receiver may be a radio frequency module, optical communications receiver, or other device capable of wireless communication, depending on the mode of transmission. In the exemplary embodiment the receiver is integrated into a circuit board assembly. The circuit board allows transmission of the command data from the receiver to the drive crank. The receiver and circuit board assembly comprise a transmission-reception component capable of receiving and converting data from signal or transmission form to command form capable of actuating movement of the drive ring.

A remote controller is capable of wireless transmission of data with the receiver and drone camera. The remote controller is a downlink receiver for image data transmitted from the drone camera and an uplink transmitter of command data to the receiver. The exemplary controller includes a user interface. The user interface can display the image data from the drone camera. The remote controller also has input components, i.e. buttons, icons, etc., enabling the operator to input commands. Based on the command input, the crank drive engages and rotates the drive ring around the polarization access to the desired orientation. Rotation through the entire polarization spectrum is possible. When the light transmissive element is in the desired position the drive ring and crank drive are locked in place, creating the stability required for high quality photography. The filter may access the drone or camera's energy source. Alternative embodiments may contain their own battery or alternative energy source.

Alternative embodiments may rotate the frame relative to the camera lens housing. This may include a mechanical component capable of exerting transverse force on the lens housing as means of rotating the frame.

An alternative embodiment may rotate the camera lens housing relative to the camera or other optical device to achieve the desired polarization angle. The drive ring would be located on the camera lens housing, or the camera lens housing would be a drive ring itself. The crank drive aspect can either be located on the outside, inside, or on the body of the camera. The crank drive can engage the drive ring to rotate the lens housing. The polarizer filter would remain stationary relative to the lens housing.

Alternative embodiments may utilize a different type of mechanical component or method to rotate the light transmissive element, such as electromagnetism. In an exemplary electromagnetic model, two anchor magnets of opposing polarities would be placed on the inside of the frame at the ends of the rotation range. Rotation magnets of the same polarity would be placed on drive ring at the ends of the rotation range. Command data activates the anchor magnet towards which rotation is desired. The drive ring locks in place when the commanded orientation is reached.

Polarizer filters are often combined with neutral density filters for enhanced image saturation capability. Alternative embodiments would allow removal and installation of light transmissive elements of different image altering capability. Interchangement of light transmissive elements would enable use of the same frame with light transmissive elements of different image alteration capabilities.

The receiver, circuit board assembly, and crank drive may be enclosed in the frame or camera body. Frame dimensions and alternative arrangements of the components may allow alternative configurations of the components relative to each other. The receiver may also transmit the command data to the crank drive wirelessly.

The control hub may have an opening to facilitate transmission of the command data to the receiver.

### BRIEF DESCRIPTION OF THE DRAWINGS

FIG. 1 shows a front view of a filter with the polarization axis shown.

FIG. 2A shows a front sectional view of an exemplary rotation mechanism within the frame.

FIG. 2B shows a side sectional view of an exemplary embodiment

FIG. 3 shows a front sectional view of an embodiment utilizing magnetism as means of rotation force.

FIG. 4 shows a schematic drawing of the remote rotation process.

### DRAWINGS: LIST OF REFERENCE NUMERALS

11 Polarizer Filter
12 Remote Controlled Filter
21 Polarization Axis
22 Extension of Polarization Axis
23 Frame
24 Rotation Magnet
25 Light Transmissive Element
26 Anchor Magnet
31 Drive Ring
33 Crank Drive
41 Control Hub
43 Receiver
45 Coupling Rim
47 Processor Assembly
49 Circuit wires
50 Drone
52 Drone Camera
61 User Interface
63 Inputs
65 Remote Controller
70 Command data
71 Image data

### DETAILED DESCRIPTION OF THE DRAWINGS

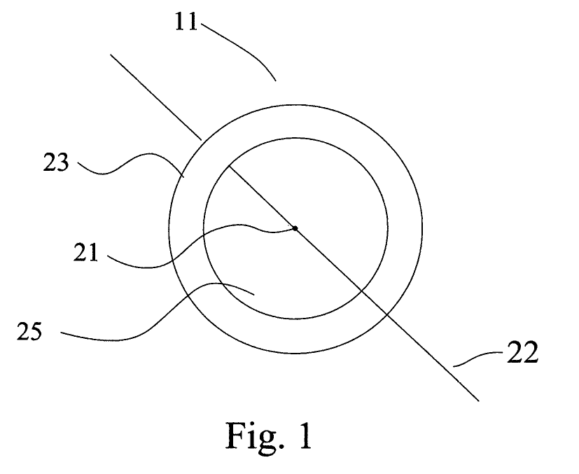

The prior art is depicted in FIG. 1. A polarizer filter 11 has a polarization axis 21 located in the middle of the light transmissive element 25. The line 22 represents the perpendicular extension of the polarization axis 21 in front of and behind the filter 11. The polarizer filter 11 is rotated relative to the polarization axis 21 to achieve the desired polarization angle. A frame 23 couples the light transmissive element 25.

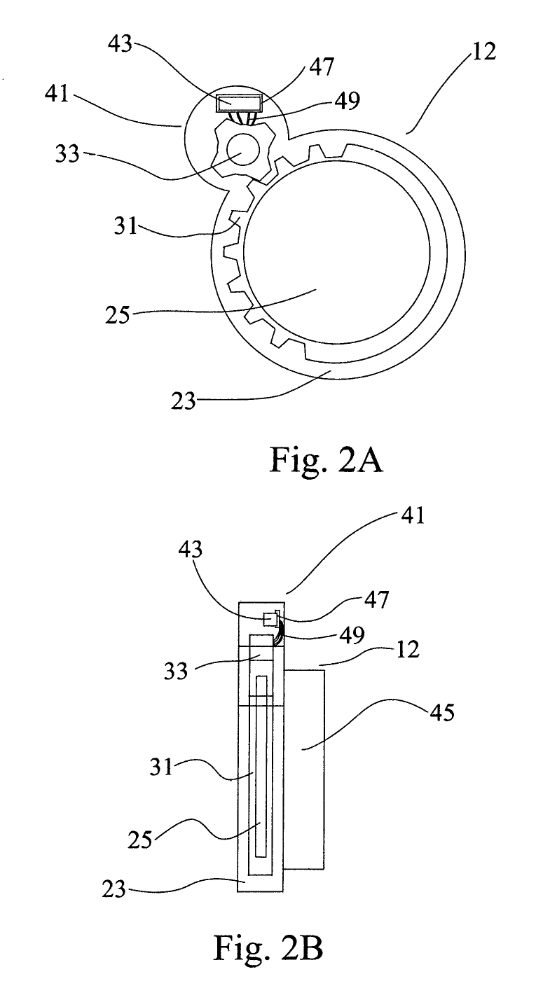

FIG. 2A shows a sectional view of mechanical components of the remote-controlled filter 12 aspect of the invention. A drive ring 31 is encased in the frame 23. The light transmissive element 25 is attached to the drive ring 31. A section of ridges along an outer portion of the drive ring 31 allow engagement with a crank drive 33 and rotation to the desired polarization angle. The outer wall of the frame 23, opens to and conjoins with a control hub 41. A receiver 43, or transmission-reception component, serves as an uplink receiver and processes command transmissions. The receiver 43 is integrated into a circuit board assembly 47 capable of processing or converting the transmitted data as needed. The processed command data is transmitted to the crank drive 33 via circuit wires 49. The crank drive 33 has teeth capable of contacting and exerting rotational force on the drive ring 31. The crank drive 33 rotates the drive ring 31 in either a clockwise or counter-clockwise direction based on the transmitted command.

FIG. 2B illustrates a sectional side view of the mechanical components of the filter aspect of the invention. A coupling rim 45 is attached to the back of the frame 23. The coupling rim 45 enables coupling with a camera housing via pressure fitting, threading, or other method. The control hub 41 can be seen above and behind the frame 23. The crank drive 33 is aligned with and behind the driver ring 31.

The circuit processor assembly 47 is connected to the crank drive 33. The circuit wires 49 permit transmission of the command data.

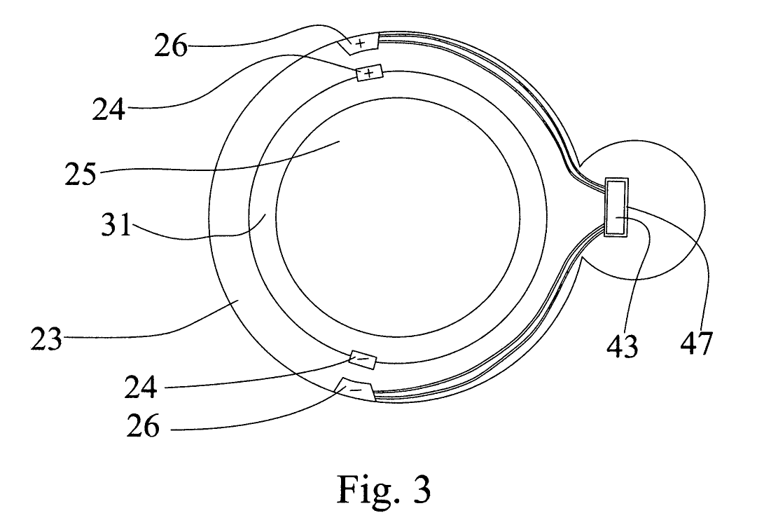

FIG. 3 shows an electromagnetic embodiment of the remote-controlled filter. Two anchor magnets 22 are attached to the inside of the outer wall of the frame 23. The anchor magnets 26 are placed at the boundary of rotation range. Two rotation magnets 24 are aligned with the anchor magnets 26 on the drive ring 31. The + and − signs on the magnets signify their relative polarities. The rotation magnet 24 is the same polarity as the anchor magnet 22 it is aligned with in the filter's unactuated state. When the anchor magnet 26 towards which rotation is desired is activated, the aligned rotation magnet 24 is repelled and the rotation magnet 24 of the opposing, polarity moves toward the anchor magnet 26 until the desired orientation is reached. Circuit wires 49 connect the receiver and circuit processor assembly 47 and receiver 43, and permit activation of the anchor magnets 26 based on transmitted command data. The command data may also be wirelessly transmitted to the anchor magnets 26. When the desired orientation is achieved the magnet (26) is deactivated and the drive ring (31) locked in place until reactivated.

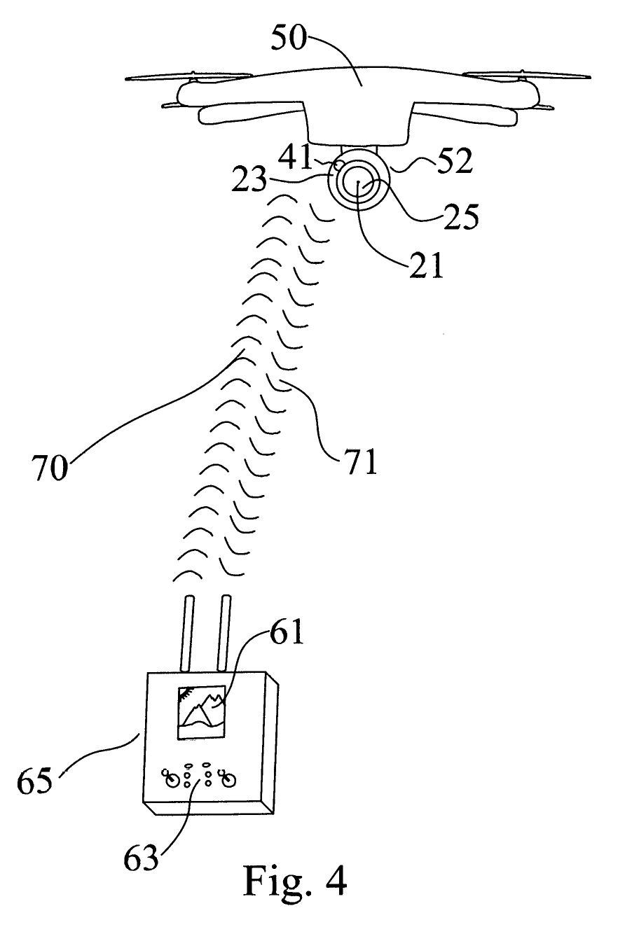

FIG. 4 is a schematic drawing of the remote adjustment process. The remote-controlled filter 12 is removably coupled with a drone camera 52. Image data 71 recorded by the drone camera 52 is transmitted to the remote controller 65 and displayed on the user interface 61. In this embodiment the remote controller 65 is a handheld device with uplink transmitter and downlink receiver capabilities. Based on the images displayed on the user interface 61, the operator uses the controller inputs 63 to send command data 70 to the receiver 43. The receiver 43 processes the commands and actuates the crank drive 33 to correctly orient the light transmissive element 25. The frame 23 remains stationary while the crank drive 333 rotates the drive ring 31 to the desired polarization angle.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the following claims.

I claim:

1. A remotely controlled optical device, comprising:
a. a camera filter comprised of a frame and light transmissive element;
b. Said frame comprised of a stationary component capable of removably coupling with a camera and a drive ring;
c. said drive ring being operatively coupled with the light transmissive element and the stationary component;
d. said drive ring capable of rotation relative the stationary component and encased therein;
e. a receiver capable of receiving wirelessly transmitted command data and processing the data and activating the drive ring to rotate according to said command data.

2. The device in claim 1, wherein there is a mechanical component capable of exerting pressure on the drive ring as means of rotation.

3. The device in claim 1, wherein the frame and drive ring are comprised of magnetic components as means of rotation.

4. A device allowing the remote adjustment of a camera filter, comprising:
a. a circular polarizer camera filter, comprised of a circular frame capable of coupling with a camera housing, a mechanical component, a transmission-reception component, and a light transmissive element capable of polarization correction;
b. said mechanical component comprised of a drive ring and a crank drive;
c. said drive ring surrounding and attaching with the light transmissive element and operatively coupling with the frame;
d. said drive ring being capable of rotation relative to the frame;
e. said crank drive being capable of exerting force on the drive ring, as means of rotation;
f. a transmission-reception component capable of receiving remotely transmitted data and converting said remotely transmitted data from signal or transmission form to mechanical command form;
g. a circuit assembly as a means of transmitting the command data from the transmission reception component to the crank drive;
h. said crank drive being actuated by manually input command data to exert pressure on and rotate the drive ring;
i. a remote controller capable comprised of inputs capable of generating command data, said remote controller being capable of wirelessly transmitting said command data to the transmission-reception component.

5. The device in claim 4, wherein the frame and mechanical component permit the installation and removal of light transmissive elements of different image altering capability.

6. A method of adjusting camera filters, comprising:
a. a camera filter capable of coupling with a camera integrated with, or attached to a vehicle;
b. said filter being comprised of a light transmissive element capable of rotation and a receiver capable of receiving wirelessly transmitted command data from a remote controller;
c. said remote controller being comprised of a receiver capable of receiving and processing the image data, and inputs allowing input of commands;

7. The method in claim 6, wherein the camera or vehicle can transmit image data to a remote device and receive command data from a remote device.

8. The method in claim 7, wherein the controller being comprised of a receiver capable of receiving and processing the image data to a remote device, and an interface capable of displaying said image data.

9. (canceled)
